(19) United States
(12) Patent Application Publication
(10) Pub. No.: US 2026/0160378 A1
(43) Pub. Date: Jun. 11, 2026

(54) SUPPORT DEVICE FOR HAIR STYLING MANNEQUIN

(71) Applicant: Forward-MFG LLC, Porter, TX (US)

(72) Inventor: Monique Cherie FREDERICKS, Kingwood, TX (US)

(21) Appl. No.: 18/974,870

(22) Filed: Dec. 10, 2024

(51) Int. Cl. F16M 11/08; A47F 8/00; F16M 11/24

(52) U.S. Cl. CPC F16M 11/08; A47F 8/00; F16M 11/242

(57) ABSTRACT

A positioning device for a mannequin head. The device includes two or more motors that provide rotational motion about orthogonal axes, each motor having a position sensor operably connected thereto that detects the rotational position of the motor during use of the device. The device further includes a control unit in electronic communication with each of the two or more motors and the position sensors, and a controller in wireless communication with the control unit via a remote communication interface. The controller allows input of a desired position for each of the two or more motors. Additional components include a housing that encloses the two or more motors, a top attachment element to secure the mannequin head to the positioning device, and optionally a support stand for the positioning device, and software useful to provide control of the positioning device on a client device.

### TECHNICAL FIELD

This disclosure generally relates to a support device for a mannequin head, and more precisely to a positioning device that provides automated adjustment of the pose of a mannequin head connected to the support stand.

### BACKGROUND

In the field of hair styling, the use of specialized tripods to support a mannequin head is common for training, demonstration, and practice purposes. Standard mannequin head tripods are designed to hold the mannequin head securely while providing a stable and manually adjustable platform for stylists to perform various hair styling techniques. Despite their widespread use, these tripods exhibit several limitations that impact their effectiveness and practicality.

One primary issue is the lack of adjustability in standard tripods. Many models offer limited range of motion and positioning options, which restricts the stylist's ability to achieve the ideal angle and height necessary for detailed and precise work. This constraint can hinder the stylist's ability to perform intricate techniques or to view the hair from all necessary perspectives.

Stability is another significant concern. Standard mannequin head tripods are often prone to wobbling or tipping, particularly when the mannequin head is subjected to movement or manipulation. Moreover, connection between the mannequin head and the tripod is often not secure, due largely to a mismatch in sizes of the attachment region on the tripod and the mannequin head. For example, the attachment region on the mannequin head may become enlarged and/or deformed after many uses. These sources of instability can disrupt the styling process, leading to potential inaccuracies and difficulties in achieving the desired results.

Overall, the above noted issues with standard mannequin head tripods underscore the need for improved designs that address adjustability, stability, and/or durability to better meet the needs of hair stylists and enhance the efficiency and precision of hair styling tasks.

### BRIEF SUMMARY

The systems and methods of the present disclosure solve many of the aforementioned problems by providing a positioning device that permits electronic control over a plurality of motors to provide automated adjustment of the pose of a mannequin head connected to the support stand. As used herein, the term “pose” should be understood to indicate a certain position, which may be achieved by movement of the mannequin head, such as rotation about two or more of the x-axis, the y-axis, and the z-axis, wherein the y-axis is defined by a longitudinal extent of the positioning device.

According to its major aspects, and briefly stated, the present disclosure relates to a positioning device for a mannequin head. The device generally includes two or more motors configured to provide rotational motion. Each of these motors may include a position sensor operably connected thereto and configured to detect a rotational position of the motor during use of the device.

The device further comprises a control unit in electronic communication with each of the two or more motors and the position sensors, the control unit having a remote communication interface, and a controller in wireless communication with the control unit via the remote communication interface. The control unit is generally configured to allow input of a desired rotational position for each of the two or more motors, such as via instruction signals sent from the controller, to achieve a desired pose of the mannequin head. An actual position of the two or more motors may be sent as a signal from the position sensor of each to the control unit.

Finally, the device may include a housing configured to surround and enclose the two or more motors, and a top attachment element configured to accept a corresponding attachment region on a mannequin head and provide secure connection for the mannequin head to the positioning device.

According to certain aspects, the two or more motors may be connected in sequence along a substantially vertical axis, wherein the vertical axis is defined by the longitudinal extent of the positioning device. Moreover, the two or more motors may comprise three motors positioned within the housing, each of the three motors configured to provide rotational motion about a different axis. For example, a first of the three motors may provide rotation about an x axis, a second of the three motors may provide rotation about a y axis, and a third of the three motors may provide rotation about a z axis.

According to certain aspects, the device may include a support stand, wherein the support stand comprises a tripod, a chair attachment device, or a table attachment device. The device may further include a bottom attachment element configured to provide attachment of the positioning device to a top end of the support stand. In some configurations, the positioning device is integral with the support stand.

According to certain aspects, the device may include a fourth motor positioned on the support stand and configured to provide vertical motion along the y-axis with respect to a longitudinal extent of the support stand. Alternatively, the fourth motor may be releasably or non-releasably connected to a bottom of the positioning device.

According to certain aspects, the device may also include a battery configured for releasable or non-releasable attachment to the support stand or positioning device, and an electrical connection extending from the battery to the control unit. For example, the battery may be releasably attachable to a leg of a tripod. The battery may provide power to each of the control unit and the two or more motors.

According to certain aspects, the top attachment element may comprise a reverse colet, a compression fitting, or the like. According to certain aspects, when the positioning device is provided as a separate component from the support stand, the bottom attachment element of the positioning device may comprise a threaded connection, a compression fitting, and the like configured to provide attachment to a top end of the support stand.

According to certain aspects, the top attachment element comprises a main body having a longitudinal extend delimited by a top end and a bottom end, and a central bore extending therethrough, wherein an upper region of the central bore proximate to the top end of the main body comprises an enlarged inner diameter relative to the remainder of the central bore. The main body is formed by at least three segments, each segment having a base connected to an adjacent segment that together form the bottom end of the main body, and a top region with an increasingly diminished thickness that together form the enlarged inner diameter of the central bore of the main body. The top attachment element further comprises a dial having a central bore extending therethrough and configured to receive the bottom end of the main body, wherein at least a portion of the central bore of the dial includes a threaded region; and a dowel sized and configured to fit within the central bores of the main body and the dial, the dowel comprising a top region having an expanded outer diameter sized and configured to fit within the upper region of the central bore of the main body and a bottom externally threaded region configured for connection with the threaded region of the central bore of the dial. Rotation of the dial threadedly pulls the dowel into the central bore of the main body and forces the at least three segments radially outward to expand an outer diameter of the main body.

The present disclosure also relates to a positioning device comprising: a first rotary motor configured to rotate about an X axis, a second rotary motor configured to rotate about a Y axis, and a third rotary motor configured to rotate about a Z axis, wherein the first, second, and third rotary motors are connected in sequence along a substantially vertical axis, e.g., connected in any order in sequence. A position sensor may be operably connected to each of the first, second, and third rotary motors, wherein each of the position sensors may be configured to detect a rotational position of the first, second, or third rotary motors during use of the system.

Further, the system may include a control unit in electronic communication with the first, second, and third rotary motors and each of the position sensors, wherein the control unit includes a remote communication interface that provides wireless communication with a controller. The control unit is generally configured to allow input of a desired position for each of the first, second, and third rotary motors, such as received via signal from the controller. Further, an actual position of the first, second, and third rotary motors may be sent as a signal from each of the position sensors to the control unit.

According to certain aspects, the device may comprise any of a housing, a top attachment element, optionally a bottom attachment element, a fourth motor, a support stand, and/or a battery as described hereinabove and in the detailed description below.

The present disclosure also relates to a positioning system comprising any of the positioning devices disclosed herein and computer-readable instructions that, when executed by a processor, cause the processor to perform any one or more of (i) through (iii): wherein (i) comprises receiving an instruction to move the at least two motors to a user selected position and sending a signal to the control unit to move the at least two motors to the user selected position, (ii) comprises registering a pose of the top attachment element defined by a distinctive position for each of the at least two motors and saving the pose to a database linked to a user account, and (iii) comprises receiving an instruction to move the at least two motors to the pose and sending a signal to the control unit to move the at least two motors to the distinctive positions for each.

According to certain aspects of the system, the processor is a user processor on a user device, wherein the user device is any of a mobile phone, a tablet, or a computer. According to certain aspects of the system, the processor is a cloud processor. Alternatively, the processor comprises a combination thereof, e.g., certain of the computer-readable instructions are executed by the user device and certain computer-readable instructions are executed on a cloud processor.

The present invention further provides an attachment device, which may be used in any of the embodiments disclosed hereinabove to secure a mannequin head and may also find use to afford connection to an internal bore of any device or article. The attachment device generally comprises a cylindrical body defining a central bore extending along a longitudinal length thereof, the cylindrical body formed by a plurality of petals secured along a lower end region thereof to form the bottom of the cylindrical body. The plurality of petals may be configured to expand along a length of the cylindrical body to enlarge an upper region thereof. The attachment device further comprises an expansion mechanism configured to drive the petals outward. The expansion mechanism generally comprises a dowel element or central rod disposed within the central bore of the cylindrical body, the dowel element having an expanded region at a top end thereof, and a narrower region at a bottom end thereof. The expanded region of the dowel element is configured to engage with an upper region of the central bore having a larger inner diameter, and the narrower region of the dowel element is configured to fit within a lower region of the central bore having a smaller inner diameter. A threaded portion of the dowel element at a lower end is configured for engagement with a nut that is operable to move the dowel element relative to the cylindrical rod, wherein turning the nut moves the dowel element downward to expand the petals outward and increase the outer diameter of the cylindrical body.

According to certain aspects, the expanded region of the dowel element is configured to be in close proximity to, or in contact with, an inner wall of the central bore in the upper region of the cylindrical body. The nut is operable to shorten the dowel element, thereby forcing the expanded region of the dowel downward into the narrower lower region of the cylindrical rod, thereby expanding the petal elements outward.

### BRIEF DESCRIPTION OF THE DRAWINGS

Aspects, features, benefits, and advantages of the embodiments herein will be apparent with regard to the following description, appended claims, and accompanying drawings. In the following figures, like numerals represent like features in the various views. It is to be noted that features and components in these drawings, illustrating the views of embodiments of the presently disclosed invention, unless stated to be otherwise, are not necessarily drawn to scale. The present invention described herein may be better understood by reference to the accompanying drawing sheets, in which:

FIG. 1 illustrates a mannequin head attached to a motorized positioning device and support stand according to aspects of the present disclosure.

FIG. 2 illustrates a motorized positioning device and support stand according to aspects of the present disclosure.

FIG. 3A illustrates an exemplary attachment mechanism for a mannequin head according to aspects of the present disclosure.

FIG. 3B illustrates a cross-sectional view of the attachment mechanism shown in FIG. 3A.

FIG. 3C illustrates a cross-sectional view of another exemplary attachment mechanism for a mannequin head according to aspects of the present disclosure.

FIGS. 4A and 4B illustrate a motorized positioning device and support stand according to aspects of the present disclosure, wherein FIG. 4A shows the support stand in an extended arrangement and FIG. 4B shows the support stand in a collapsed arrangement.

FIGS. 4C-4E illustrate alternative support stands for the motorized positioning device according to aspects of the present disclosure.

FIG. 5 illustrates an exemplary arrangement of a motor of the positioning device according to aspects of the present disclosure, wherein the motor is configured for movement in the y-direction with reference to the plane of a floor surface (x-direction).

FIG. 6 illustrates an exemplary controller configured to control each of the motors of the positioning device according to aspects of the present disclosure.

FIG. 7 illustrates a close-up view of the various components of the positioning device according to aspects of the present disclosure.

FIG. 8 illustrates another close-up view of the various components of the positioning device according to aspects of the present disclosure.

FIG. 9 illustrates a closeup view of a motors and position sensor of the positioning device and connections for each to the control unit.

FIG. 10 illustrates another motorized positioning device according to aspects of the present disclosure.

FIG. 11 illustrates an exemplary computing environment configured to carry out certain aspects of the methods of the present disclosure.

### DETAILED DESCRIPTION

In the following description, the present invention is set forth in the context of various alternative embodiments and implementations of a portable positioning device for a mannequin head. The positioning device includes motors configured to provide motion of an upper attachment element to which the mannequin head is attachable, and a wireless controller allowing user control over the motors. Also provided are systems that include the positioning device and controller, and a support stand such as a tripod or attachment for a table or chair. Further yet provided are systems including the positioning device and controller, and software configured to enable a user device to control the motors and optionally create a user account. In some versions of the software, the user may store specific poses of the upper attachment element and thus the mannequin head attached thereto, position the upper attachment element at a previously stored pose, create notes on a hair style or sequence of poses of the upper attachment element used during creation of a hair style, and the like.

### Definitions and Abbreviations

Various aspects of the devices and methods of use thereof disclosed herein may be illustrated by describing components that are coupled, attached, and/or joined together. As used herein, the terms “coupled,” “connected,” “attached,” and/or “joined” are interchangeably used to indicate either a direct connection between two components or, where appropriate, an indirect connection to one another through intervening or intermediate components. In contrast, when a component is referred to as being “directly coupled,” “directly connected,” “directly attached,” and/or “directly joined” to another component, there are no intervening elements shown in said examples. Thus, as example, when it is indicated that the motors are connected in sequence along a substantially vertical axis, the motors may be directly connected to each other or may be connected via intervening elements.

Various aspects of the devices and methods of use thereof disclosed herein may be illustrated with reference to one or more exemplary implementations. As used herein, the term “exemplary” means “serving as an example, instance, or illustration,” and should not necessarily be construed as preferred or advantageous over other variations of the systems, devices, and methods disclosed herein. “Optional” or “optionally” means that the subsequently described component, event, or circumstance may or may not be included or occur, and the description encompasses instances where the component or event is included and instances where it is not.

Furthermore, throughout the specification, reference to “one embodiment,” “an embodiment,” or “some embodiments” means that a particular described feature, structure, or characteristic is included in at least one embodiment. Thus, appearances of the phrases “in one embodiment,” “in an embodiment,” or “in some embodiments” in various places throughout this specification are not necessarily all referring to the same embodiment. Those skilled in the art will recognize that the various embodiments can be practiced without one or more of the specific details or with other methods, components, materials, etc. In other instances, well-known structures, materials, or operations are not shown or not described in detail to avoid obscuring aspects of the embodiments.

Certain terminology is used in the following description for convenience only and is not limiting. The words “lower,” “upper,” “bottom,” “top,” “front,” “back,” “left,” “right” and “sides” designate directions in the drawings to which reference is made but are not limiting with respect to the orientation in which the various parts of the systems and devices disclosed herein may be used unless otherwise indicated.

It must also be noted that as used herein and in the appended claims, the singular forms “a,” “an,” and “the” include the plural reference unless the context clearly dictates otherwise. Thus, as example, reference to “a” motor, or “an” offset element, or “the” gearbox may be reference to one or more of any of these components.

Unless defined otherwise, all technical and scientific terms used herein have the same meanings as commonly understood by one of ordinary skill in the art.

All numerical quantities stated herein are approximate, unless indicated otherwise, and are to be understood as being prefaced and modified in all instances by the term “about.” The numerical quantities disclosed herein are to be understood as not being strictly limited to the exact numerical values recited. Instead, unless indicated otherwise, each numerical value included in this disclosure is intended to mean both the recited value and a functionally equivalent range surrounding that value.

All numerical ranges recited herein include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value equal to or less than 10.

As generally used herein, the terms “include,” “includes,” and “including” are meant to be non-limiting. As generally used herein, the terms “have,” “has,” and “having” are meant to be non-limiting.

### ASPECTS AND EMBODIMENTS OF THE PRESENT DISCLOSURE

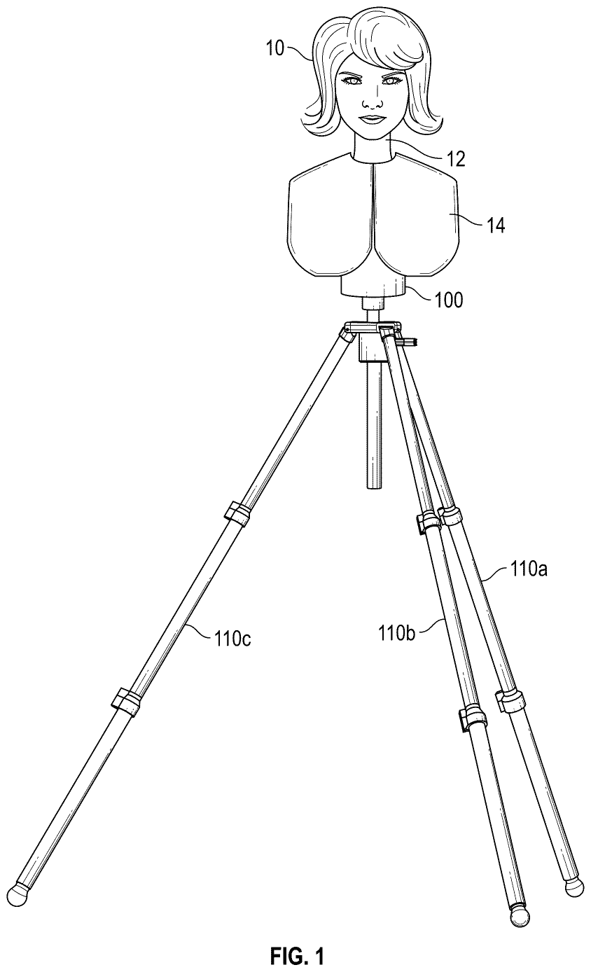

Various implementations of the positioning device for a mannequin head and systems comprising the positioning device are illustrated in FIGS. 1-10.

With specific reference to FIG. 1, a positioning device 100 of the present disclosure generally comprises two or more motors configured to provide rotational motion and thus enable user selected orientations or poses of an upper attachment element. A mannequin head 10, such as one used in the practice or demonstration of hair styling, may be secured on the positioning device 100 via an upper or top attachment element. The positioning device 100 may further include a lower or bottom attachment element configured to provide attachment to a support stand, such as a tripod (110a-c).

As shown in FIG. 1, the positioning device may further provide support and/or attachment of additional components, such as a frame positionable on a top of the positioning device 100 and/or attached via the top attachment element of the positioning device 100. Such a frame may be useful to support an apron 14 or other elements that may mimic the size, shape, and/or look of a human's shoulders and/or upper torso.

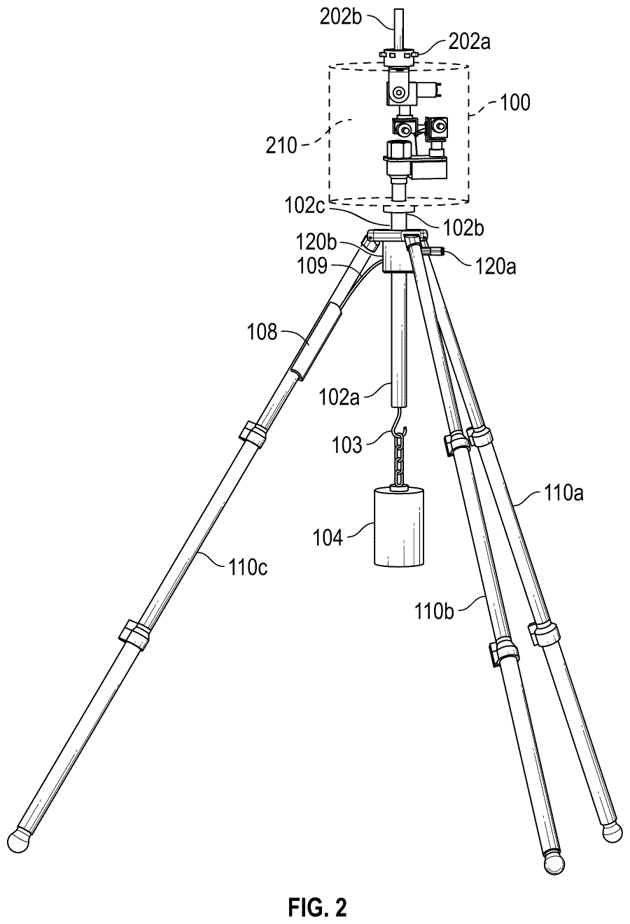

With reference to FIG. 2, the positioning device 100 may include a housing 210 that surrounds and encloses the various motors of the positioning device 100, such as the two or more motors that provide rotational motion about mutually orthogonal axes. The top attachment element 202b may extend from a top of the housing 210 and a bottom attachment element 102b may be positioned on or extend from a bottom of the housing 210 and may be configured for attachment to a support device such as a tripod (110a-c).

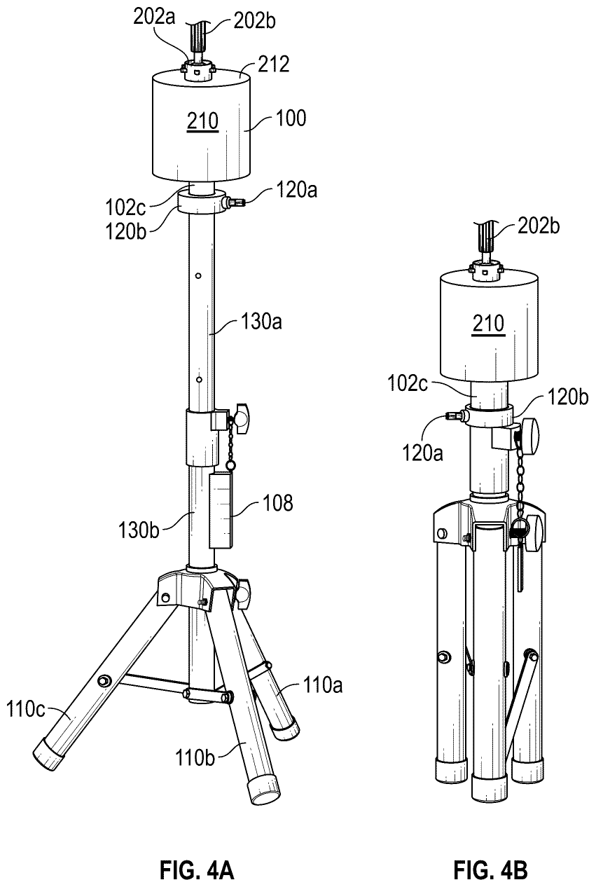

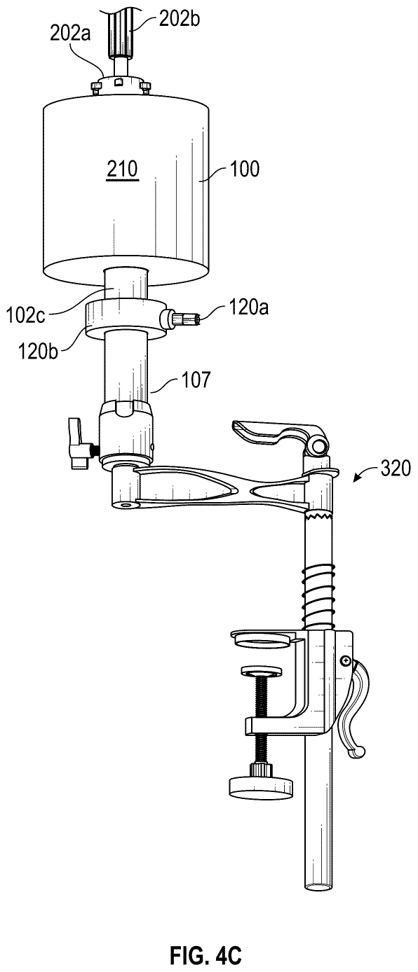

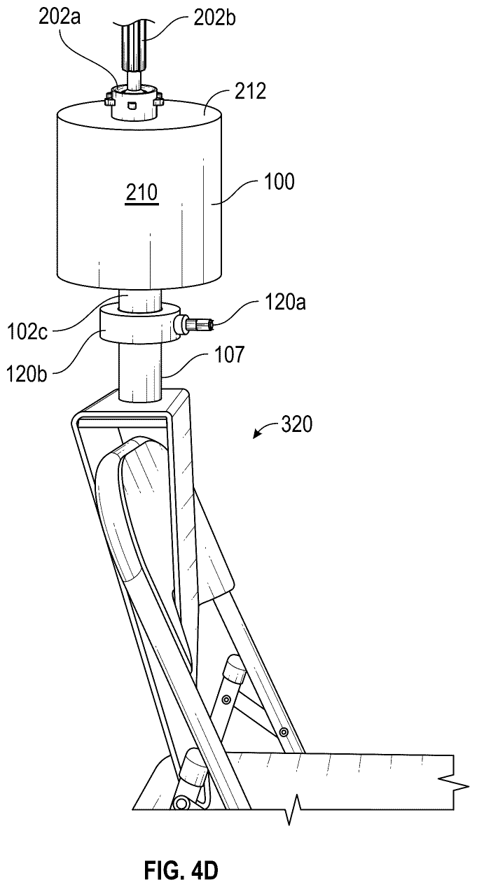

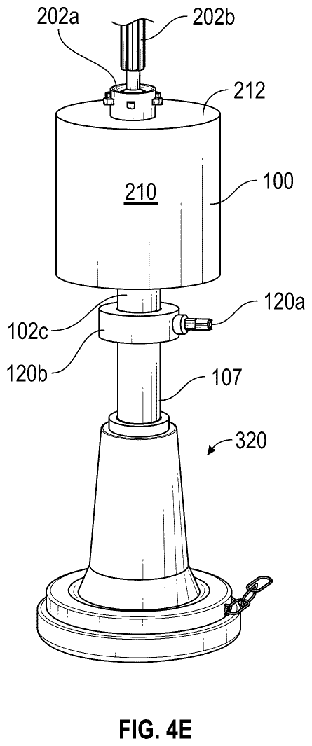

According to certain aspects, such as when the support stand is a tripod (110a-c), a means to further stabilize the tripod may be included. For example, as illustrated, the tripod may include a vertical extension rod 102a onto which weight 104 may be connected via a connection element, such as via a hook 103 at an end thereof. The additional weight may be any weight known in the art or any that is attachable via the connection element. The weight may be included with the positioning device 100 and support stand or may be provided by a user of the system. Alternatively, or additionally, weight may be added to legs of the support stand, such as weight included within the legs (e.g., 110a-110c of FIG. 4A) of a tripod or attachable to an outer region of the lowest portion of a telescoping leg (e.g., FIG. 2) of the tripod.

Typical mannequin heads 10 include an open region on a base of the head or neck 12 region thereof that is configured for connection with standard sized and shaped attachment elements. Over time, the opening at the base of the mannequin head 10, which is typically in a neck region 12, may become deformed or expanded such that connection to a standard attachment element is less secure. The attachment elements of the present disclosure address this issue by including regions that expand upon connection with the mannequin head 10 to account for differently sized and/or shaped openings in the mannequin head 10.

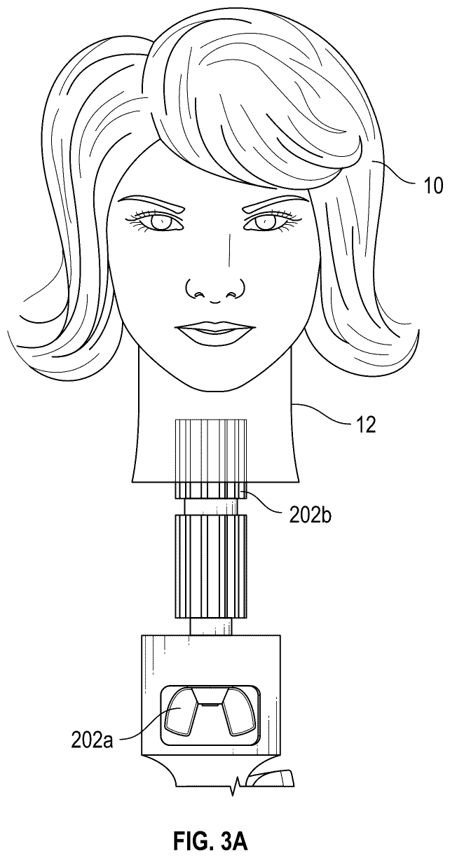

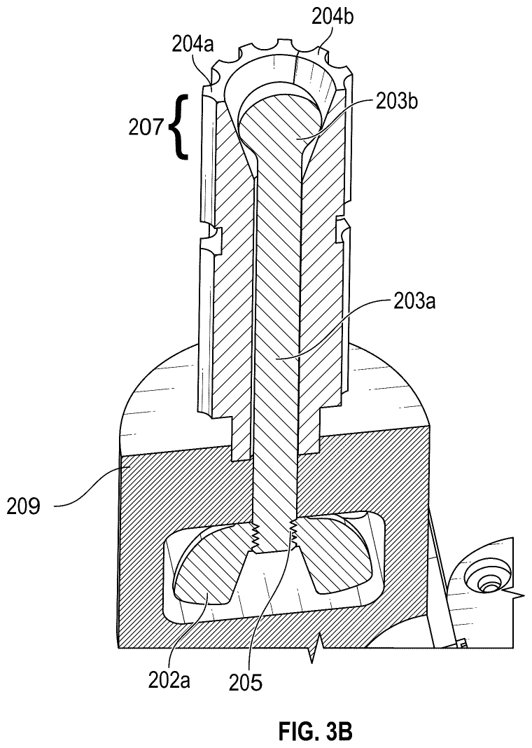

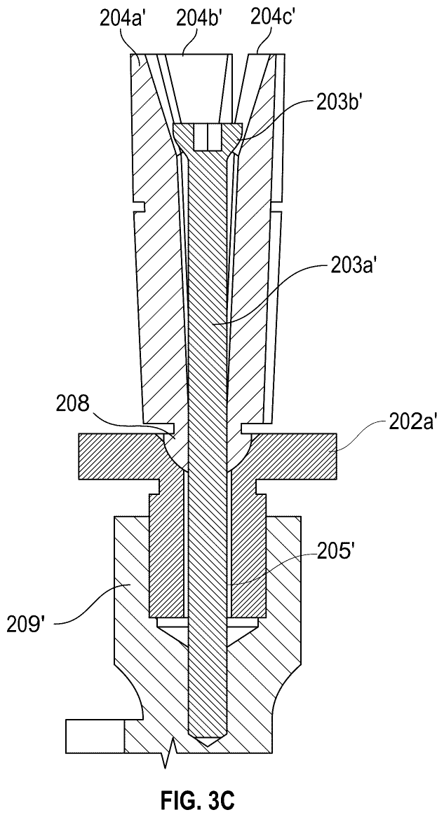

For example, and with reference to FIGS. 3A and 3B, the top attachment element 202b is typically a cylindrical rod with a central bore. The top attachment element 202b may include three or more “petals” (only two are shown, 204a, 204b) secured along a lower end region of each to form a lower region of the top attachment element. The petals expand along a length thereof to enlarge at least the upper region of the top attachment element 202b. As such, the mannequin head 10 may be positioned over the top attachment element 202b when it is in a closed arrangement, such as shown in FIG. 3A, and the petals of the top attachment element 202b may be opened to secure the mannequin head 10 thereon, akin to a reverse colet (see for example FIG. 3C).

One means to expand the petals of the attachment element 202b is illustrated in FIG. 3B. As shown, a dowel 203a having an expanded region 203b at a top end thereof may be positioned inside of and fit snugly within an upper region 207 of the central bore of the top attachment element that has an increased inner diameter (i.e., an outer circumference of the expanded region 203b of the dowel 203a may be in close proximity to, or in contact with, an inner wall of the central bore in the upper region 207). The remainder of the dowel 203a fits snugly within a lower region of the attachment element having a smaller internal diameter (i.e., an outer circumference of the dowel 203a may be in close proximity to, or in contact with, an inner wall of the central bore). A base of the dowel 204c may include threads 205 configured to provide threaded connection to a nut 202a, which in certain configurations may be partially enclosed within a housing 209. Turning the nut 202a to shorten the dowel pulls the expanded region 203b of the dowel 203a downward into the lower region of the top attachment element (i.e., region having an inner diameter that is smaller than a diameter of the expanded region of the dowel), thus forcing the petals (204a, 204b) outward and enlarging an outer diameter of the top attachment element. While the threads 205 are shown to be included in only a lower portion of the dowel 203a, a larger portion, or all of the lower portion of the dowel 203a, may include threads.

An alternate arrangement of the top attachment element 202b is illustrated in FIG. 3C. The top attachment element 202b may include three or more petals (204a′, 204b′, 204c′) secured along a lower end region of each to form a lower region 208 of the top attachment element. The petals expand along a length thereof to enlarge at least the upper region of the top attachment element 202b. The dowel 203a′ includes an expanded region 203b′ at a top end thereof positioned within an upper region of the central bore of the top attachment element that has an increased inner diameter. A base of the dowel 204c′ may include threads 205′ configured to provide threaded connection to a nut 202a′. Turning the nut 202a′ to shorten the dowel pulls the expanded region 203b′ of the dowel 203a′ downward into the lower region of the top attachment element (i.e., region having an inner diameter that is smaller than a diameter of the expanded region of the dowel), thus forcing the petals (204a′, 204b′, 204c′) outward and enlarging an outer diameter of the top attachment element. As shown, the nut 202a′ in this configuration may be a dial (e.g., circumferential expanded region) or a standard nut (e.g., includes wings).

In yet another alternative configuration, and with reference to FIG. 2, the top attachment element 202b may be any standard attachment element known in the art and/or may include a region 202a having protrusions configured for connection with an inner bore of the mannequin head (e.g., elastomeric protrusions).

The bottom attachment element 102b may be a threaded attachment configured to provide connection with a corresponding threaded attachment element on a top of a tripod, or a corresponding threaded attachment element on a top of a quick release tripod adapter. Alternatively, the bottom attachment element 102b may be sized and shaped as a bottom of a tripod quick release adapter, i.e., may include outward extending sides that may be captured by a lock system on the top of a standard tripod. In certain configurations, the positioning device 100 may be integrally formed with a portion of the support stand, as will be discussed in more detail below.

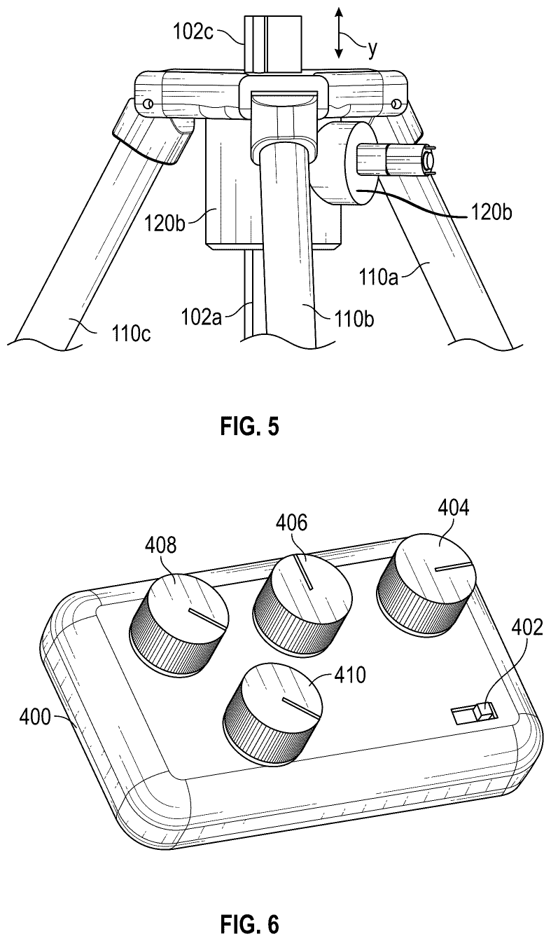

With reference to FIGS. 2 and 5, an additional motor (120a, 120b; also referred to herein as the fourth motor) may be included that is attachable or integral with the support stand (e.g., tripod as shown in FIGS. 2 and 5). This fourth motor (120a, 120b) may provide vertical motion along the y-axis with respect to longitudinal extent of the support stand. As example, a motor 120a may provide vertical motion of an expansion pole 102c, such as through a central region 120b of the fourth motor comprising the gears and within the vertical extension rod 102a. As shown, the fourth motor (120a, 120b) is positioned at the apex of the three legs (110a-c) of the tripod and may be integral with the tripod or attachable thereon, such as via any of the means disclosed herein. The expansion pole 102c may extend downward into the vertical extension rod 102a of the tripod such that the range of vertical motion is limited only by the length of the vertical extension rod 102a and/or the expansion pole 102c.

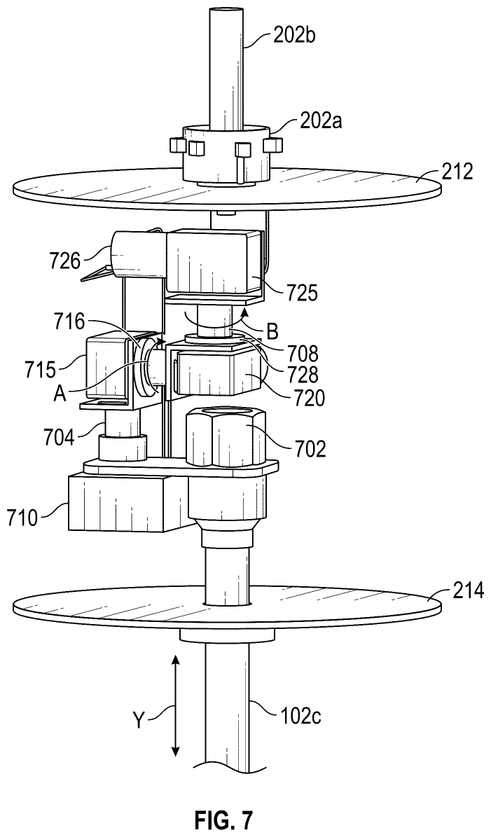

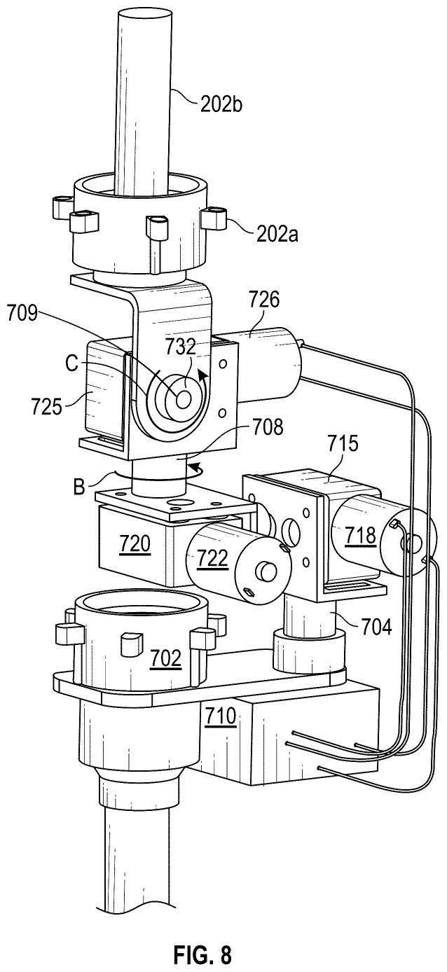

Also shown in FIG. 2 is a possible position of a battery pack 108 configured to provide power to each of the motors of the positioning device 100. The battery pack 108 may be releasably attachable or non-releasably connected to the support stand (e.g., a leg 110c of a tripod) and may include a power cable 109 attachable to a control unit of the positioning device (710 of FIG. 7). Alternatively, the battery pack may be releasably attachable or non-releasably connected to the positioning device 100.

With reference to FIGS. 4A-4E, several configurations of a support stand according to aspects of the present disclosure are illustrated. For example, the support stand may be a tripod, much as illustrated in FIGS. 1 and 2, wherein an arrangement of the legs (110a-c) may differ, i.e., the legs do not meet at a central apex but are positioned around a central telescoping pole. In such a case, and as illustrated in FIGS. 4A and 4B, the battery pack 108 may be releasably attachable or non-releasably connected to the support stand, such as on a lower portion 130a of the telescoping pole, wherein electrical connection between the battery pack 108 and a control unit of the device may include a cable (e.g., 109) positioned within the telescoping pole (130a, 130b). Alternatively, the cable may remain free and simply extend from the battery pack to the connection point on the positioning device.

The fourth motor (120a, 120b), when included, may provide vertical motion of an expansion pole 102c, such as through a central region of the fourth motor and within an innermost pole 130a of the telescoping pole. As shown, the fourth motor (120a, 120b) may be releasably or non-releasably connected to the support stand, such as at the top of the innermost pole 130a of the telescoping.

Alternatively, the support stand may be a clamp 320 configured for connection to a table or countertop, as illustrated in FIG. 4C, or configured for attachment to a chair, such as onto a back of the chair as shown in FIG. 4D, or a suction device, such as shown in FIG. 4E. In any of these configurations, the positioning device 100 may be connected or attachable to the clamp, such as via an expansion pole 102c and/or extension element 107. When included, the fourth motor (120a, 120b) may provide vertical motion of the expansion pole 102c, such as through a central region of the fourth motor and within the extension rod 107.

With reference to FIGS. 7 and 8, the inner region of the positioning device is illustrated, wherein only the top 212 and bottom 214 portions of the housing are shown. The positioning device includes at least two motors configured for rotation motion, such as rotation about an x, y, or z-axis. The positioning device shown in FIGS. 7 through 9 includes three motors, one for each of the x, y, and z axes. A first motor (715, 718) provides rotation ‘A’, a second motor (720, 722) provides rotation ‘B’, and a third motor (725, 726) provides rotation ‘C.’ Each of the first, second, and third motors include a motor (718, 722, 726, respectively) that drives gears in a gear box (715, 720, 725, respectively) that provides rotation of an axle (706, 708, 709, respectively). These motors are connected in sequence along a substantially vertical axis, i.e., along a longitudinal extent of the positioning device.

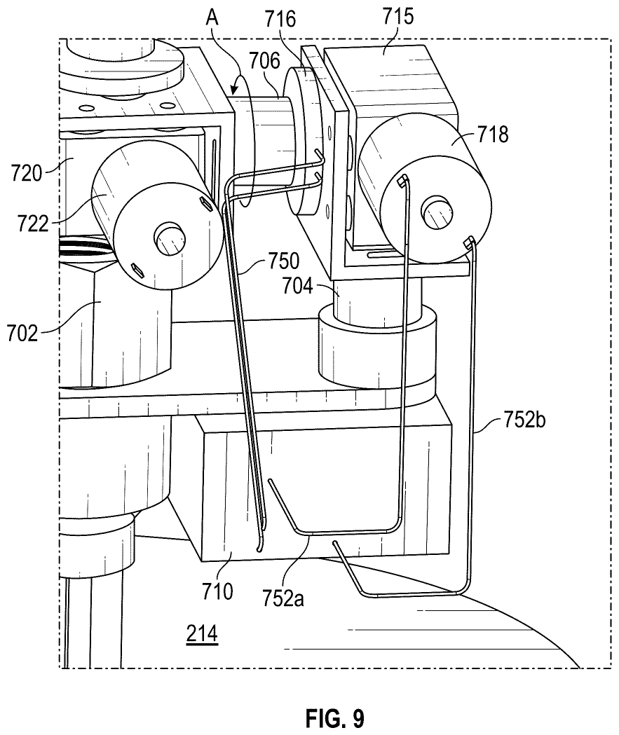

Each of the two or more motors may include a position sensor. For example, as shown in FIGS. 7 and 8, each of the first, second, and third motors include a position sensor (716, 728, 732, respectively). Each position sensor is configured to detect a relative or absolute position of the axle (e.g., 706, 708, 709) of the associated motor and relay that information to a control unit 710. Each of the motors is configured to be in electrical communication with the control unit. For example, a position sensor 716 of the first motor (715, 718) is positioned on an axle 706 and configured to detect a rotational position of the axle. A position sensor 728 of the second motor (720, 722) is positioned on an axle 708 and configured to detect a rotational position of the axle. A position sensor 732 of the third motor (725, 726) is positioned on an axle 709 and configured to detect a rotational position of the axle. The position sensors are each electrically connected to the control unit to receive power and provide data communication. For example, and with reference to FIG. 9, the position sensor 716 of the first motor (715, 718) is electrically connected to the control unit 720 via connections 750 that provide power and/or data communication. Also shown is the motor 718 of the first motor that is electrically connected to the control unit 710 via connections (752a, 752b) that provide power and/or data communication.

The position sensors may be any known in the art, such as rotary potentiometers, Hall-effect sensors, resolvers, or rheostats. In certain preferred configurations, a rheostat is included to measure the voltage drop as electrical contact(s) slide along a resistive track, wherein the position is proportional to the voltage output.

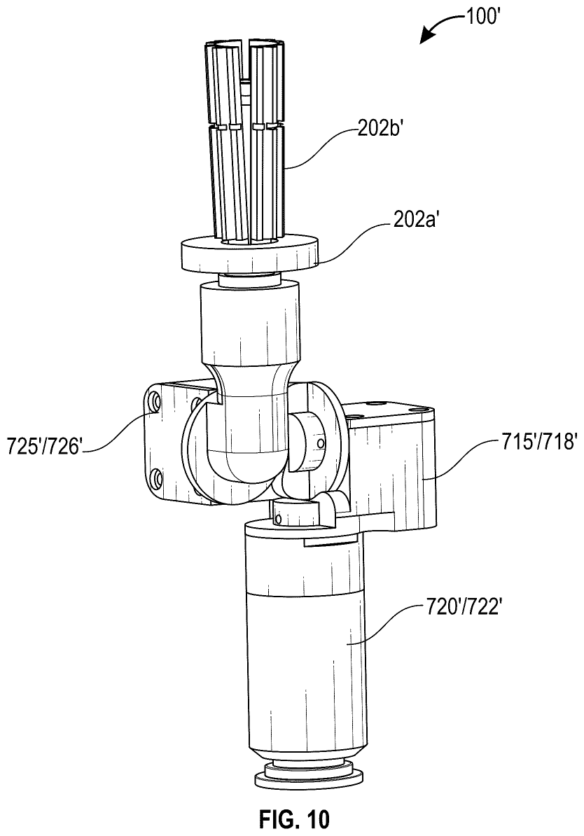

Another configuration of the positioning device 100 of the present disclosure is illustrated in FIG. 10. As shown, each of the motors and gear boxes may be individually encased in a housing. Starting from a bottom of the positioning device 100, a first motor (720′, 720′) provides the rotation ‘B’, a second motor (715′, 718′) provides rotation ‘A’, and a third motor (725′, 726′) provides rotation ‘C.’ As shown, these motors are connected in sequence along a substantially vertical axis, i.e., along a longitudinal extent of the positioning device.

The control unit 710 is in data communication with a controller 400 (see FIG. 6), typically via wireless communication effectuated by a remote communication interface included in each of the control unit 710 and the controller 400. In some configurations, the controller 400 could be directly connected to the control unit 710 via a communication cable. While not preferred, such a connection may be provided as a backup communication line between the controller and the control unit, or as the sole communication line between the controller and the control unit. As such, each of the controller and the control unit may include data ports configured for connection of a communication wire or cable.

The controller 400 may include a power switch 402 configured to turn the controller on or off. In general, the controller may be powered by any standard battery positioned within the controller and accessible via an opening in the housing of the controller (e.g., a panel on a bottom side of the controller). As shown, the controller may include a dial (e.g., 404, 406, 408, 410) useful to control each of the two or more motors of the positioning device 100, i.e., allow input of a desired position for each of the two or more motors, which is then sent as a signal to the control unit and then to each of the position sensors.

While the controller 400 is shown as including a dial useful to control each of the motors, other means to input desired motion of the motor are possible and within the scope of the present disclosure. For example, the control unit may include a touch screen, thumb stick, joystick, directional buttons, or any other means capable of providing control over the two or more motors of the positioning device 10.

The positioning device 100 and controller 400 may be part of a system that further includes computer readable instructions executable on a client device, such as a cell phone, tablet, computer, and the like. The computer readable instructions may be configured to perform any of (i) receive an instruction to move the at least two motors to a user selected position and send a signal to the control unit to move the at least two motors to the user selected position, (ii) register a specific position of each of the at least two motors and save the specific position to a database linked to a user account, and optionally, (iii) receive an instruction to move the at least two motors to the specific position and send a signal to the control unit to move the at least two motors to the user specific position. The computer readable instructions may be further configured to provide a user account having specific user identification and security measures (e.g., username and password), and options for further functionality, such as storing sequences of poses for a mannequin head attached to the positioning device, notes on specific hair styles, notes on client preferences for hair styles, etc.

### Implementations of the System

Portions of the disclosed technology can be provided as a cloud-based software application accessible from a client device via an internet connection. Portions of the disclosed technology can also be provided as software, in the form of non-transitory computer-readable media, such as a software application installed locally on a client device. The disclosed technology can also be provided as a combination of the two, i.e., both a locally installed software application configured to interact with a cloud-based server and/or database.

Accordingly, certain portions of the system disclosed herein can be implemented using computer-executable instructions stored on one or more computer-readable media (e.g., non-transitory computer-readable media, such as one or more optical media discs, volatile memory components (such as DRAM or SRAM), or nonvolatile memory components (such as flash drives or hard drives)) and executed on a computer (e.g., any commercially available computer, proprietary computer, purpose-built computer, or supercomputer, including smart phones or other mobile devices that include computing hardware).

Any of the computer-executable instructions for implementing the disclosed systems, as well as any data created and used during implementation of the disclosed software, can be stored on one or more computer-readable media (e.g., non-transitory computer-readable media). The computer-executable instructions can be part of, for example, a dedicated software application, or a software application that is accessed or downloaded via a web browser or other software application (such as a remote computing application). Such software can be executed, for example, on a single local computer (e.g., as a process executing on any suitable commercially available computer) or in a network environment (e.g., via the Internet, a wide-area network, a local-area network, a client-server network (such as a cloud computing network), or other such network) using one or more network computers.

For clarity, details regarding software and implementations thereof that are well known in the art are omitted. For example, it should be understood that the disclosed technology is not limited to any specific computer language or program, nor is the disclosed technology limited to any particular computer or type of hardware. Certain details of suitable computers and hardware are well-known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

### Example Computing Environments

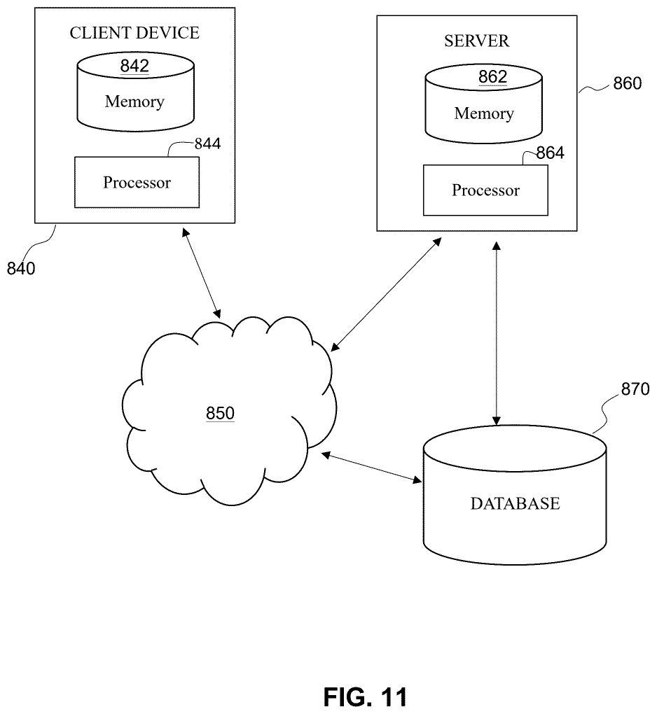

FIG. 11. illustrates a generalized example of a suitable computing environment (840, 860) in which the software of the disclosed systems can be implemented. For example, the computing environment can implement all of the computer-implemented functions described herein, e.g., setting up user accounts, allowing selection or setting of rotational or vertical positions of the various motors, storing and later accessing preset rotational or vertical positions of one or more of the motors, etc.

The computing environment may be a client computing environment 840 wherein all of the computer-implemented functions or modules configured to execute the disclosed methods are executed on a client processor 844 using instructions stored on local client memory 842. The computing environment may be a server computing environment 860 (computing cloud) wherein all of the computer-implemented functions or modules configured to execute the disclosed methods are executed on a server processor 864 using instructions stored on a server memory 862. A user may access the computing cloud from their client computing environment 840, e.g., a primary filesystem can be in the computing cloud (860, 870), while a disclosed file index can be operated in the client computing environment 840.

The computing environment is not intended to suggest any limitation as to scope of use or functionality of the technology, as the technology can be implemented in diverse general-purpose or special-purpose computing environments. For example, the disclosed technology can be implemented with other computer system configurations, including handheld devices, multiprocessor systems, microprocessor-based or programmable consumer electronics, network PCs, minicomputers, mainframe computers, and the like. The disclosed technology can also be practiced in distributed computing environments where tasks can be performed by remote processing devices that can be linked through a communications network (850). In a distributed computing environment, program modules can be located in both local memory (842) and remote memory (862, 870) storage devices.

With continued reference to FIG. 11, the computing environment (840, 860) generally includes at least one central processing unit (844, 864) and memory (842, 862). The central processing unit (844, 864) executes computer-executable instructions and can be a real or a virtual processor. In a multi-processing system, multiple processing units execute computer-executable instructions to increase processing power and, as such, multiple processors can be running simultaneously.

The memory (842, 862) can be volatile memory (e.g., registers, cache, RAM), nonvolatile memory (e.g., ROM, EEPROM, flash memory, etc.), or some combination of the two. The memory (842, 862) stores at least software, and optionally certain data sets and images that can, for example, implement the technologies described herein. As should be readily understood, the term memory may include computer-readable media (e.g., non-transitory computer-readable media, such as one or more optical media discs, volatile memory components (such as DRAM or SRAM), or nonvolatile memory components (such as flash drives or hard drives)) and is not transmission media such as modulated data signals.

The computing environment can have additional features. For example, the computing environment (840, 860) may include one or more input devices, one or more output devices, and one or more communication connections. An interconnection mechanism (not shown) such as a bus, a controller, or a network, interconnects the components of the computing environment (840, 860). Typically, operating system software (not shown) provides an operating environment for other software executing in the computing environment, and coordinates activities of the components of the computing environment. The terms computing environment, computing node, computing system, and computer are used interchangeably.

The memory (842, 862) can be removable or non-removable, and includes magnetic disks, magnetic tapes or cassettes, CD-ROMs, CD-RWs, DVDs, or any other medium which can be used to store information and that can be accessed within the computing environment. The memory (842, 862) may store instructions for the software, which can implement technologies described herein. The input device(s) can be a touch input device, such as a keyboard, keypad, mouse, touch screen display, pen, or trackball, a voice input device, a scanning device, or another device, which provides input to the computing environment (840, 860). The input device(s) can also include interface hardware for connecting the computing environment to control and receive data from host and client computers, storage systems, or administrative consoles.

Accordingly, while particular embodiments have been illustrated and described, it would be obvious to those skilled in the art that various other changes and modifications may be made without departing from the spirit and scope of the invention. Those skilled in the art will recognize or be able to ascertain using no more than routine experimentation, numerous equivalents to the specific apparatuses and methods described herein, including alternatives, variants, additions, deletions, modifications, and substitutions. This application including the appended claims is therefore intended to cover all such changes and modifications that are within the scope of this application.

Reference Numbers

| | |
|---|---|
| 10 | Mannequin Head |
| 12 | Neck region of the mannequin head |
| 14 | Hair styling Apron |
| 100 | Positioning device |
| 102a | Vertical extension rod |
| 102b | Bottom attachment element |
| 102c | Expansion pole of the tripod |
| 103 | Connector (e.g., hook) |
| 104 | Weight |
| 107 | Extension element |
| 108 | Battery pack |
| 109 | Electrical connector for battery |
| 110a, b, c | Legs of the tripod |
| 120a | Fourth motor |
| 120b | Gear box of fourth motor |
| 130a, b | Telescoping poles of the tripod |
| 202a | Nut of the top attachment element 202b |
| 202b | Top attachment element |
| 203a | Dowel |
| 204a-c | Petals of the top attachment element 202b |
| 205 | Threaded region of dowel 203a |
| 207 | Upper region of the central bore of 202b |
| 209 | Housing for the nut 202a |
| 210 | Housing |
| 212 | Top portion of the housing |
| 214 | Bottom portion of the housing |
| 400 | Controller |
| 402 | On/off switch for the controller |
| 404, 406, | Rotational and vertical adjustment dials |
| 408, 410 | |
| 702 | Attachment knob |
| 704 | Offset element |
| 706, 708, 709 | Axles |
| 710 | Control unit |
| 715 | Gearbox of the first motor |
| 716 | Positional sensor for the first motor |
| 718 | First motor |
| 720 | Gearbox of the second motor |
| 722 | Second motor |
| 725 | Gearbox of the third motor |
| 726 | Third motor |
| 728 | Positional sensor for the second motor |
| 732 | Positional sensor for the third motor |
| 750 | Electrical connectors between positional sensor and |
| | control unit |
| 752a, 752b | Electrical connectors between first motor and control unit |
| 840 | Client computing environment |
| 842 | Client memory |
| 844 | Client processor |
| 850 | Internet |
| 860 | Server computing environment |
| 862 | Server memory |
| 864 | Server processor |
| 870 | Database |

What is claimed is:

1. A positioning device comprising:
two or more motors configured to provide rotational motion, each of the two or more motors having a position sensor operably connected thereto and configured to detect a rotational position thereof during use of the device;
a control unit in electronic communication with each of the two or more motors and the position sensors, the control unit having a remote communication interface;
a controller in wireless communication with the control unit via the remote communication interface, wherein the control unit is configured to allow input of a desired position for each of the two or more motors, and wherein an actual position of the two or more motors is sent as a signal from the position sensor of each of the two or more motors to the control unit;
a housing configured to surround and enclose the two or more motors; and
a top attachment element configured to accept a corresponding attachment region on a mannequin head and provide secure connection for the mannequin head to the positioning device.

2. The device of claim 1, wherein the two or more motors are connected in sequence along a substantially vertical axis.

3. The device of claim 1, wherein the two or more motors comprise three motors positioned within the housing, each of the three motors configured to provide rotational motion on a different axis.

4. The device of claim 3, wherein a first of the three motors provides rotation about an x axis, a second of the three motors provides rotation about a y axis, and a third of the three motors provides rotation about a z axis.

5. The device of claim 1, comprising:
a support stand, wherein the support stand comprises a tripod, a chair attachment device, or a table attachment device.

6. The device of claim 5, comprising:
a fourth motor positioned on the support stand and configured to provide vertical motion along a y axis with respect to a horizontal floor surface.

7. The device of claim 5, comprising:
a battery configured for releasable attachment to a leg of the support stand and electrical connection to the control unit,
wherein the battery provides power to each of the control unit and the two or more motors.

8. The device of claim 1, wherein the top attachment element comprises a reverse colet, a compression fitting, or a compressible elastomeric fitting.

9. The device of claim 1, wherein the top attachment element comprises:
a main body having a longitudinal extend delimited by a top end and a bottom end, and a central bore extending therethrough, wherein an upper region of the central bore proximate the top end of the main body comprises an enlarged inner diameter;
a dial having a central bore extending therethrough and configured to receive the bottom end of the main body, wherein at least a portion of the central bore includes a threaded region; and
a dowel sized and configured to fit within the central bores of the main body and the dial, the dowel comprising a top region having an expanded outer diameter sized and configured to fit within the upper region of the central bore of the main body and a bottom externally threaded region configured for connection with the threaded region of the central bore of the dial,
wherein the main body is formed by at least three segments, each segment having a base connected to an adjacent segment that together form the bottom end of the main body, and a top region with an increasingly diminished thickness that together form the enlarged inner diameter of the central bore of the main body,
wherein rotation of the dial threadedly pulls the dowel into the central bore of the main body and forces the at least three segments radially outward to expand an outer diameter of the main body.

10. A positioning device comprising:
a first rotary motor configured to rotate about an X axis, a second rotary motor configured to rotate about a Y axis, and a third rotary motor configured to rotate about a Z axis, wherein the first, second, and third rotary motors are connected in sequence along a substantially vertical axis;
a position sensor operably connected to each of the first, second, and third rotary motors, each of the position sensors being configured to detect a rotational position of the first, second, or third rotary motors during use of the system;
a control unit in electronic communication with the first, second, and third rotary motors and each of the position sensors, the control unit having a remote communication interface; and
a controller in wireless communication with the control unit via the remote communication interface,
wherein the control unit is configured to allow input of a desired position for each of the first, second, and third rotary motors, and
wherein an actual position of the first, second, and third rotary motors is sent as a signal from each of the position sensors to the control unit.

11. The device of claim 10, comprising:
a housing configured to surround and enclose the first, second, and third rotary motors; and
a top attachment element configured to accept a corresponding attachment region on a mannequin head and provide secure connection for the mannequin head to the positioning device.

12. The device of claim 10, comprising:
a support stand, wherein the support stand comprises a tripod, a chair attachment device, or a table attachment device, and wherein the positioning device is integral with the support stand or releasably attachable to the support stand.

13. The device of claim 10, comprising:
a battery having an electrical connection port for connection to the control unit,
wherein the battery provides power to each of the control unit and the first, second, and third motors.

14. The device of claim 10, comprising:
a fourth motor positioned on the support stand and configured to provide vertical motion along the y axis with respect to a horizontal floor surface.

15. The device of claim 14, comprising:
a support stand, wherein the support stand comprises a tripod, a chair attachment device, or a table attachment device, and wherein the positioning device is integral with the support stand or releasably attachable to the support stand; and
a battery configured for releasable attachment to a leg of the support stand and having an electrical connection port for connection to the control unit,
wherein the battery provides power to each of the control unit and the first, second, third, and fourth motors.

16. The device of claim 15, comprising:
a bottom attachment element configured to provide attachment of the positioning device to a top end of the support stand.

17. A positioning system comprising:
the positioning device according to claim 1; and
computer-readable instructions that, when executed by a processor, cause the processor to perform any one or more of (i) through (iii):
(i) receive an instruction to move the at least two motors to a user selected position and send a signal to the control unit to move the at least two motors to the user selected position,
(ii) register a specific position of each of the at least two motors and save the specific position to a database linked to a user account,
(iii) receive an instruction to move the at least two motors to the specific position and send a signal to the control unit to move the at least two motors to the user specific position.

18. The system of claim 17, wherein the processor is a user processor on a user device, wherein the user device is any of a mobile phone, a tablet, or a computer, or wherein the processor is a cloud processor, or wherein the processor comprises a combination thereof.

19. A positioning system comprising:
the positioning device according to claim 10; and
computer-readable instructions that, when executed by a processor, cause the processor to perform any one or more of (i) through (iii):
(i) receive an instruction to move one or more of the first, second, and third rotary motors to a user selected position and send a signal to the control unit to move the one or more of the first, second, and third rotary motors to the user selected position,
(ii) register a specific position of each of the first, second, and third rotary motors and save the specific position to a database linked to a user account,
(iii) receive an instruction to move one or more of the first, second, and third rotary motors to the specific position and send a signal to the control unit to move the one or more of the first, second, and third rotary motors to the user specific position.

20. The system of claim 19, wherein the processor is a user processor on a user device, wherein the user device is any of a mobile phone, a tablet, or a computer, or wherein the processor is a cloud processor, or wherein the processor comprises a combination thereof.
